(19) United States
(12) Patent Application Publication
(10) Pub. No.: US 2006/0064221 A1
(43) Pub. Date: Mar. 23, 2006

(54) Operator selectable control pattern

(76) Inventors: Mark A. Sporer, Apex, NC (US); Michael S. Freberg, Raleigh, NC (US); Dante T. Thomas, Garner, NC (US); Paul A. Dvorak, Sanford, NC (US)

Correspondence Address: CATERPILLAR INC.;100 N.E. ADAMS STREET, PATENT DEPT., PEORIA, IL, 616296490, US

(21) Appl. No.: 10/946,539

(22) Filed: Sep. 21, 2004

(51) Int. Cl. G06F 19/00

(52) U.S. Cl. 701/50; 37/414; 172/4.5

(57) ABSTRACT

A method and apparatus of a work machine wherein the operator changes the control pattern of the work machine by selecting the control pattern from a plurality of control patterns stored in a controller. A first input device is actuated to select a predetermined control pattern for at least one control member. The controller enables an algorithm to change from a first control pattern to a second control pattern in response to the selected predetermined control pattern.

### TECHNICAL FIELD

This invention relates generally to operator selectable control patterns, and, more particularly, to an apparatus and method for an operator of a work machine to change the control pattern by selecting from a plurality of control patterns of the work machine.

### BACKGROUND

Work machines such as integrated tool carriers, skid steer loaders, backhoe loaders, excavators, and other work machines typically have a plurality of implements that are attached to the work machine to perform particular work functions. The work machines and the implements are normally controlled through at least one control member such as joysticks and foot pedals. This typically includes controlling the direction of movement of the work machine, the speed of the work machine, and the implement's lift mechanism, tilt mechanism, and auxiliary mechanisms. Many work machines and implements use different movements of the control member to control such work machine and/or implement. In other words, the control members of different work machines and/or implements have different control patterns to perform a particular function. It can be difficult for an operator that is familiar with one control pattern to use a work machine and/or implement having a different control pattern. It is, therefore, beneficial for an operator to have the ability to change the control patterns of the work machine and/or implements.

One known apparatus for altering control patterns of a work machine is described in U.S. Pat. No. 6,435,289 B1 issued to Hori et. al. on Aug. 20, 2002. It discloses an apparatus for altering combinations of operation apparatuses and actuators. A switching means is provided for switching between a first combination that causes direction signals output from one operation apparatus of the two operation apparatuses (left and right) to correspond with driving directions of left and right running actuators, and a second combination that causes operation direction signals output from the left operation apparatus to correspond with drive directions of the left running actuator, and operation direction signals output from the right operation apparatus to correspond with drive directions of the right running actuator.

The present disclosure is directed to overcoming one or more of the problems as set forth above.

### SUMMARY OF THE INVENTION

According to one exemplary aspect of the present invention, a method of changing a control pattern of a work machine is disclosed. The method includes storing a plurality of control patterns in a controller operatively connected with at least one control member. The controller being operably connected to the work machine and capable of receiving a first signal from the at least one control member and using the control pattern to coordinate said first signal to an operation, is capable of sending a second signal to the work machine in response to the coordinated operation. The method further includes actuating a first input device to select a predetermined control pattern for the at least one control member and sending a third signal from the first input device to the controller upon selection of the predetermined control pattern. Furthermore the method includes changing from a first control pattern for the at least one control member to a second control pattern for the at least one control member in response to the third signal.

According to another exemplary aspect of the present invention an operator selectable control apparatus is disclosed. The apparatus includes at least one control member for controlling operations of at least one of a work machine and an implement. The apparatus further includes a controller operably connected to the control member and having a plurality of control patterns for the control member stored therein. The controller is operably connected to the work machine is capable of receiving a first signal from the at least one control member and using the control pattern to coordinate said first signal to the operations. Furthermore, the controller is capable of sending a second signal to the work machine in response to the coordinated operation. The apparatus further includes at least one device operably connected to the controller, wherein the at least one input device sends a third signal to the controller to change from a first control pattern to a second control in response to the third signal.

According to yet another exemplary aspect of the present invention a work machine is disclosed. The work machine includes a body portion and an implement connected with the body portion. The work machine further includes at least one control member attached to the body portion for controlling operations of at least one of the work machine and the implement, and a controller attached to the body portion and operably connected to the control member. The controller having a plurality of control patterns for the control member stored therein and being operably connected to the work machine and the implement, is capable of receiving a first signal from the at least one control member and using the control pattern to coordinate said first signal to the operations of at least one of the work machine and implement. Furthermore, the controller is capable of sending a second signal to the work machine in response to the coordinated operation. The work machine further includes at least one device operably connected to the controller, wherein the at least one input device sends a third signal to the controller to change from a first control pattern to a second control pattern in response to the third signal.

### BRIEF DESCRIPTION OF THE DRAWINGS

For a better understanding of the present disclosure, reference may be made to the accompanying drawings in which:

FIG. 1 is a diagrammatic perspective view of a work machine;

FIG. 2 is a diagrammatic top view of the work machine, and more particularly, an operator's compartment of the work machine;

FIG. 3 is a flow diagram of an algorithm to execute change in the control pattern;

FIG. 4 is a flow diagram of an alternate algorithm to execute change in the control pattern;

FIG. 5 is a diagrammatic view of a map of a predetermined control pattern; and

FIG. 6 is a diagrammatic view of a map of a selectable predetermined control pattern.

### DETAILED DESCRIPTION

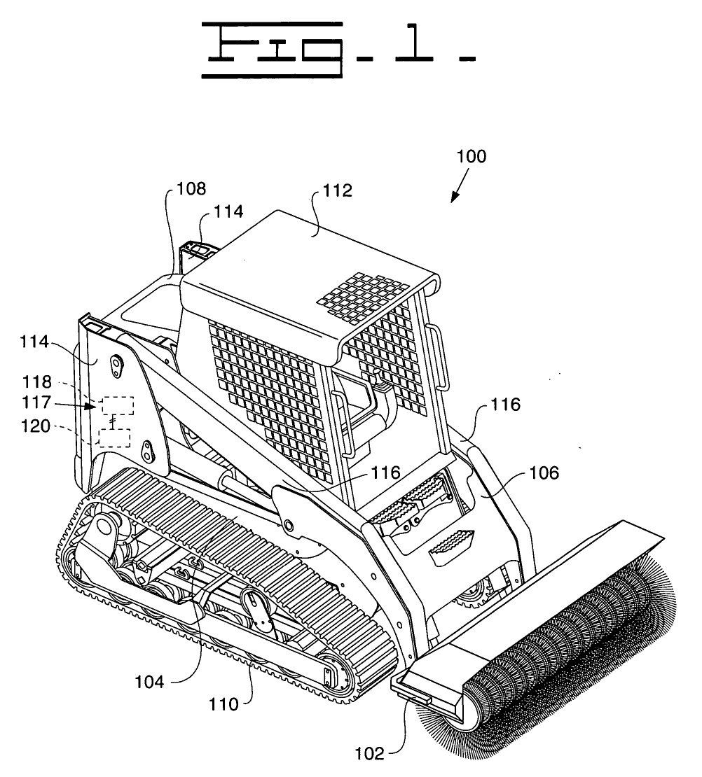

Referring to the drawings, a method and apparatus for operator selectable control patterns for use with a work machine 100 is shown. With particular reference to FIG. 1, the work machine 100 is depicted as a tracked skid steer loader with an implement 102 operatively coupled to the work machine 100. It should be understood, however, that the work machine 100 could be any sort of work machine, including, without limitation, a wheeled skid steer loader, a backhoe loader, a wheel loader, a tractor, or the like. The work machine 100, as shown, has a body portion 104 having a front-end portion 106 and a rear end portion 108. The work machine includes a at least two ground engaging support members 110 that support the body portion 104 and an operator's compartment 112 supported on the body portion 104. Further, the work machine 100 includes a pair of laterally spaced side members 114 located at the rear-end portion 108 of the body portion 104 and a pair of lift arms 116 pivotally connected to the laterally spaced side members 114. The implement 102 is pivotally connectable with the lift arms 116 at the front-end portion 106 of the body portion 104. It should be understood, however, that the implement 102 could be any sort of implement, not just the broom shown in FIG. 1, and may be mounted with only a single arm, boom and stick, or other implement mounting combinations.

The work machine 100 has connected thereto a controller 117, such as an electronic control module 118, and a hydraulic system 120. Further, the electronic control module 118 is operably connected to the hydraulic system 120. The hydraulic system 120 is configured so as to operate the work machine 100 and operate the implement 102, including, without limitation, the implement's 102 lift mechanism, tilt mechanism, and auxiliary mechanisms. These operations include, without limitation, moving the work machine 100 in forward and reverse directions, moving the work machine 100 left and right, controlling the speed of the work machine's travel, lifting and lowering the implement, tilting the implement, and the auxiliary controls of the implement such as rotating the implement, controlling the rotational speed of the implement, controlling the impaction of the implement, etc.

The electronic control module 118 may include one or more algorithms to control the work machine 100 and operate the implement 102. The electronic control module 118 includes a microprocessor (not shown), which is meant to include microcomputers, microprocessors, integrated circuits and the like capable of being programmed.

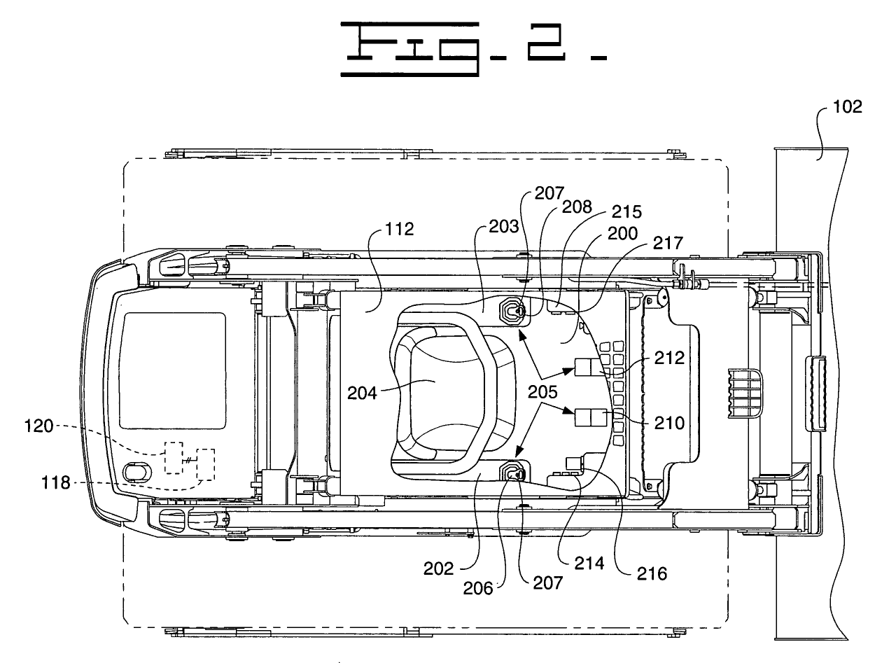

Referring to FIG. 2, the operator's compartment 112 has a bottom portion 200 and a first-side portion 202 and a second-side portion 203. The operator's compartment 112 includes a seat 204 connected to the bottom portion 200. The operator's compartment 112 further includes at least one control member 205. Four control members 205 are shown, a right joystick 206, a left joystick 208, a right foot pedal 210, and a left foot pedal 212, but it should be understood that any number of control members 205 may be used. The right and left joysticks 206, 208 are located adjacent to the seat 204 and are attached to the first-side portion 202 and the second-side portion 203 of the operator's compartment 112, respectively. The right and left foot pedals 210, 212 are attached to the bottom portion 200 of the operator's compartment 112. The control members 205 may be equipped with at least one auxiliary switch 207 such that the operator may control at least one work machine 100 or implement 102 operation.

Each of the control members 205 are operably connected to the electronic control module 118 such that the control members 205 are capable of sending a signal to the electronic control module 118 indicative of the position of the control members 205. The electronic control module 118 includes a plurality of predetermined control patterns and is capable of sending signals to the hydraulic system 120 to control the operations of the work machine 100 and the implement 102. The control patterns are defined as maps that coordinate the position of the control members 205 to the signal being sent to the hydraulic system 120. The electronic control module 118 may be programmed with the plurality of control patterns through a direct link or remotely. Authorized personnel may add or delete any one or all of the plurality of predetermined control patterns from the electronic control module 118 by a means for programming the electronic control module 118, such as physically connecting to the electronic control module 118, remotely through satellites, local area networks (LAN), wide area networks (WAN), personal data assistants (PDAs), laptops or other means for programming the electronic control module 118.

Additionally, the operator's compartment 112 may include at least one instrument panel, as shown the operator's compartment 112 includes a first instrument panel 214 located on the first-side portion 202, and a second instrument panel 215 located on the second-side portion 203. However, the locations of the first and second instrument panels 214, 215 are insubstantial to the overall function of the present invention, as long as the first and second instrument panels 214, 215 are accessible to the operator. Additionally, the use of two instrument panels is only for operator and design convenience and number of instrument panels is mutually exclusive to the functionality of the present invention. The first instrument panel 214 includes a first input device 216 such as a switch, lever, display unit, or other mechanism located thereon such that the operator can select the control pattern from the plurality of predetermined control patterns to control the work machine 100 and operate the implement 102. The first input device 216 is operably connected to the electronic control module 118 and capable of sending a signal to the electronic control module 118 indicative of the selected predetermined control pattern.

The second instrument panel 215 may include a second input device 217 such as a switch, lever, display, or other mechanism that enables a braking mechanism of the work machine 100 to apply at least one brake of the work machine 100 when actuated. The second input device 217 is operably connected to the electronic control module 118 and capable of sending a signal to the electronic control module 118 indicative of the position of the second input device 217. Alternatively, the first input device 216 and the second input device 217 may be located on either of the first and second instrument panels 214, 215.

The second input device 217 may be used as an interlock control system, wherein to change the control pattern of the control members 205, an operator actuates the first input device 216 and the second input device 217 substantially simultaneously. Alternatively the first input device 216 may be actuated then the second input device 217, or the second input device 217 then the first input device 216. Upon successful actuation of the first and second input devices 215, 216, the at least one algorithms is fully executed, in particular, a control pattern algorithm that changes the control pattern of the control members 205. If the operator does not actuate both first and second input devices 216, 217, the algorithm is not fully executed and the control pattern will not be changed. Alternatively, the interlock control system could be any sort of interlock system such as, but not limited to, U.S. Pat. No. 6,135,230 issued on Oct. 24, 2000 and assigned to the assignee of the present invention.

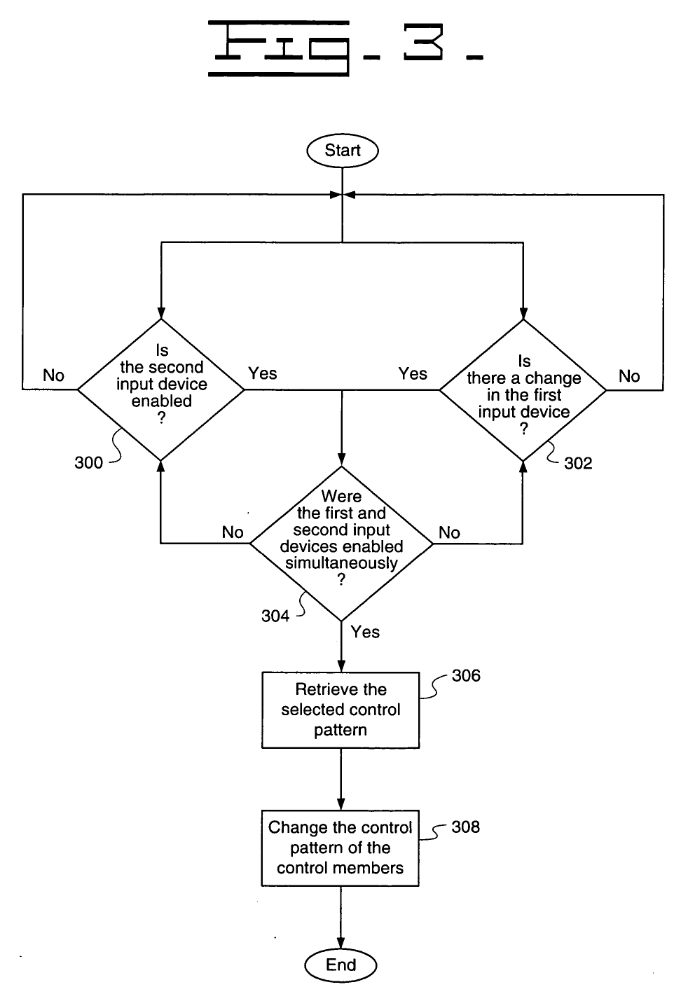

FIG. 3 further describes the control pattern algorithm. Control starts in decision blocks 300 and 302 simultaneously, wherein block 300 determines if the second input device 216 is enabled. If yes, control passes to decision block 304. Block 302 determines if the first input device 217 is enabled. If yes, control passes to decision block 304, wherein block 304 determines if the first and second input devices were enabled substantially simultaneously. If yes, control passes to block 306, wherein the selected control pattern is retrieved from the plurality of control patterns. Control then passes to block 308 wherein the control patterns for the control members 205 are changed.

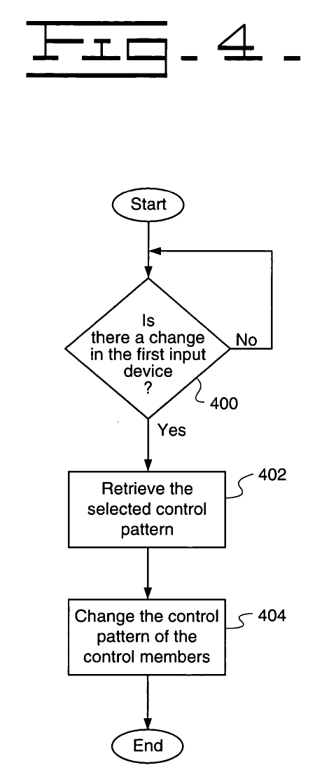

Alternatively, FIG. 4 describes another control pattern algorithm. Control starts in decision block 400, wherein block 400 determines if there is change in the first input device 217. If yes, control passes to decision block 402, wherein selected control pattern is retrieved from the plurality of control patterns. Control then passes to block 404, wherein the control patterns for the control members 205 are changed.

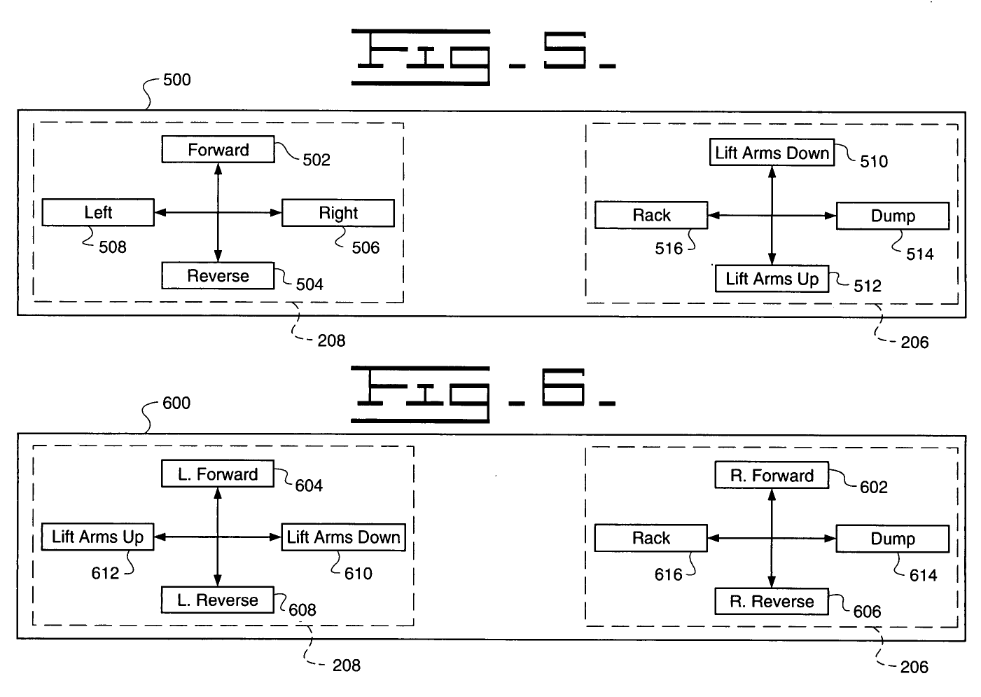

FIG. 5 shows in greater detail an exemplary predetermined control pattern. As illustrated, the control pattern would exemplify a single lever control pattern 500. The left joystick 208 controls the work machine 100 by moving the left joystick 208 to a first position 502, allowing the work machine 100 to traverse in a forward direction. To traverse the work machine 100 in reverse the left joystick 208 is moved to a second position 504. To steer the work machine 100, the left joystick 208 is moved to a third or forth 506, 508 positioned coordinating a right or left turn.

Additionally, in the exemplified single lever control pattern 500 the right joystick 206 may control the operation of the implement 102. As illustrated, moving the right joystick 206 to a first position 510 will lower the lift arms 116, and by moving the right joystick 206 to a second position 512 the lift arms 116 will raise. To rotate the implement 102, such as a bucket, to dump or rack, the right joystick may be moved to third or forth position 514, 516.

FIG. 6 shows an exemplary control pattern that may be selected by the operator, which would exemplify a dual lever control pattern 600. In the exemplified dual control pattern 600 the left and right joysticks 206, 208 control a respective side of the work machine 100 and operates the implement 102 as illustrated. To traverse the work machine 100 in forward, the right and left joysticks 206, 208 are moved to a first position 602, 604, respectively, and to traverse the work machine in reverse, the right and left joysticks are moved to a second position 606, 608. As one of ordinary skill in the art could sense, to steer the work machine 100 would require some un-uniformity in the movement of the right and left joysticks 206, 208 to the first and second positions 602, 604; 606, 608. Since each joystick 206, 208 operates a respective side of the work machine 100 in the exemplary dual lever control pattern 600, the coordination of both joysticks 206, 208 is necessary to traverse and steer the work machine 100.

Furthermore moving the left joystick 208 to third and forth position 610, 612 lowers and raises the lift arms 116, respectively. With regard to the right joystick 206 in the dual lever control pattern 600, movement to a third and forth position 614, 616 the implement is rotated to dump or rack, respectively.

It should be understood that one well versed in the art may program the electronic control module with multiple control patterns to be selected by the operator and that FIGS. 5 and 6 are only exemplary to show two alternatives. Other alternatives, for example, may include changing or enabling the foot pedals 210, 212 or auxiliary switch 207 to control the work machine 100 and operate the implement 102.

### INDUSTRIAL APPLICABILITY

An operator of the work machine 100 often finds it desirable to change the first control pattern to a second control pattern when, for example, a different implement 102 is attached to the work machine 100, when the operator is operating an unfamiliar work machine 100, or when it is more efficient or convenient to change the control pattern.

In the present invention, the work machine 100 is equipped with a plurality of control patterns wherein the operator can select one to electronically change the control pattern for the control members 205. With no need for the operator to change hardware or swap components, the number of control patterns is only limited by the number of combinations for the number of control members and operations that can be performed. If space is limited within the electronic control module 118 to store at least one control pattern, they can be added and deleted from the electronic control module 118 by one well versed in the art of programming the electronic control module 118 by either a remote or direct connection to the electronic control module 118.

To change the control pattern in an exemplary embodiment the operator would begin with the machine running and in a stationary position. Next, the operator would select the desired control pattern using the first input device 216. Upon successful actuation of the first input device 216, the electronic control module fully executes the control pattern algorithm to change the control pattern for the control members 205. Once changed the electronic control module 118 maintains the control pattern until such a time as the operator desires a change and repeats the steps for changing the control pattern.

To change the control pattern in another exemplary embodiment the operator would begin with the machine running and in a stationary position. Next, the operator would select the desired control pattern using the first input device 216 while substantially simultaneously selecting the second input device 217 to enable the braking mechanism. Upon successful actuation of the first and second input devices 216, 217, the electronic control module fully executes the control pattern algorithm to change the control pattern for the control members 205. Once changed the electronic control module 118 maintains the control pattern until such a time as the operator desires a change and repeats the steps for changing the control pattern.

Other aspects of the present invention may be obtained from study of the drawings, the disclosure, and the appended claims. It is intended that that the specification and examples be considered exemplary only.

What is claimed is:

1. A method of changing a control pattern of a work machine, said method comprising:
storing a plurality of control patterns in a controller operatively connected with at least one control member, the controller being operably connected to the work machine, the controller being capable of receiving a first signal from the at least one control member and using the control pattern to coordinate said first signal to an operation, the controller being capable of sending a second signal to the work machine in response to the coordinated operation;
actuating a first input device to select a predetermined control pattern for the at least one control member;
sending a third signal from the first input device to the controller upon selection of the predetermined control pattern; and
changing from a first control pattern to a second control pattern in response to the third signal.

2. The method of claim 1, wherein changing the first control pattern to the second control pattern includes executing an algorithm within the controller.

3. The method of claim 2, wherein executing the algorithm includes enabling an interlock control system.

4. The method of claim 3, wherein enabling an interlock control system includes:
actuating a second input device to control at least one brake of the work machine;
sending a forth signal from the second input device to the controller; and
applying the brake of the work machine.

5. The method of claim 4, wherein actuating the first input device and second input device includes:
actuating the first input device and the second input device substantially simultaneously.

6. The method of claim 4, wherein actuating the first input device and second input device includes:
actuating the first input device then the second input device.

7. The method of claim 4, wherein actuating the first input device and second input device includes:
actuating the second input device then the first input device.

8. The method of claim 1, wherein storing the plurality of control patterns includes changing the stored plurality of control patterns using a means for programming the controller.

9. An operator selectable control apparatus, comprising:
at least one control member for controlling operations of at least one of a work machine and an implement;
a controller operably connected to the control member, the controller having a plurality of control patterns for the at least one control member stored therein, the controller being operably connected to the work machine, the controller being capable of receiving a first signal from the at least one control member and using the control pattern to coordinate said first signal to the operations, the controller being capable of sending a second signal to the work machine in response to the coordinated operation; and
at least one device operably connected to the controller, wherein the at least one input device sends a third signal to the controller to change from a first control pattern to a second control in response to the third signal.

10. The apparatus of claim 9, wherein the controller includes an algorithm to change the control pattern for the at least one control member.

11. The apparatus of claim 10, further includes:
an interlock control system operably connected to the controller.

12. The apparatus of claim 11, wherein the interlock control system includes:
a second input device operably connected to the controller.

13. The apparatus of claim 12, wherein the second input device sends a forth signal to the controller to enable the interlock system.

14. The apparatus of claim 9, wherein the at least one input device includes a display unit.

15. The apparatus of claim 9, wherein the at least one input device includes lever.

16. The apparatus of claim 9, wherein the at least one control member includes at least one joystick.

17. The apparatus of claim 9, wherein the at least one control member includes at least one joystick and at least one foot pedal.

18. A work machine, comprising:
a body portion;
an implement connected with the body portion;
at least one control member attached to the body portion for controlling operations of at least one of the work machine and the implement;
a controller attached to the body portion and operably connected to the control member, the controller having a plurality of control patterns for the control member stored therein, the controller being operably connected to the work machine and the implement, the controller being capable of receiving a first signal from the at least one control member and using the control pattern to coordinate said first signal to the operations of at least one of the work machine and implement, the controller being capable of sending a second signal to the work machine in response to the coordinated operation; and
at least one device operably connected to the controller, wherein the at least one input device sends a third signal to the controller to change from a first control pattern to a second control pattern in response to the third signal.

19. The apparatus of claim 18, wherein the controller includes an algorithm to change the control pattern for the at least one control member.

20. The apparatus of claim 19, further includes:
an interlock control system operably connected to the controller; and
an algorithm to change the control pattern for the at least one control member.

21. The apparatus of claim 20, wherein the interlock control system includes:
a second input device operably connected to the controller.

22. The apparatus of claim 21, wherein the second input device sends a forth signal to the controller to enable the algorithm.
